(19) United States
(12) Patent Application Publication
(10) Pub. No.: US 2016/0127790 A1
(43) Pub. Date: May 5, 2016

(54) PROVISION OF A VIDEO MOSAIC SERVICE

(71) Applicant: Sony Corporation, Tokyo (JP)

(72) Inventor: Paul Szucs, Esslingen (DE)

(21) Appl. No.: 14/596,509

(22) Filed: Jan. 14, 2015

Related U.S. Application Data
(60) Provisional application No. 62/075,725, filed on Nov. 5, 2014.

(51) Int. Cl. H04N 21/482; H04N 21/235

(52) U.S. Cl. CPC H04N 21/482; H04N 21/2353

(57) ABSTRACT

The present invention describes a new feature of audio-visual services, whereby a video mosaic service provisioning entity (server) aggregates several individual component audio-visual services in the form of a single composite video stream, accompanied by metadata that allows the integration of the mosaic service video offering into the user interface of the user terminal.

### BACKGROUND

Video mosaic services have been implemented on broadcast TV systems, for example using the DVB set of standards. The DVB Service Information specification (ETSI EN 300 468) defines the “mosaic descriptor” to enable the signalling related to such a composite video service which comprises of several reduced-resolution component video streams aggregated into a single full-resolution video stream, carried in the DVB service multiplex in the MPEG-2 Transport Stream format used for DVB broadcast systems. The DVB broadcast receiver is able to associate a logical mosaic cell with the original full-resolution audio-visual service that is available either in the same or in a different DVB Transport Stream multiplex that is then tuned to when the user selects the respective component.

The method to provide video mosaic services in other kinds of delivery networks, for example those implemented using the 3GPP set of standards, or those that include MPEG-DASH as content transport method, is not defined.

### BRIEF SUMMARY

Embodiments of the invention are directed to systems, methods and computer program products for providing a mosaic video enabling navigation and selection of components of the mosaic video. A method comprises delivering a single coded digital video stream, the delivered coded digital video stream comprising a video mosaic of individual coded digital video streams that are composited as the single coded digital video stream; and providing metadata for enabling creation of a user interface including the video mosaic, wherein the user interface enables navigation of the video mosaic and selection of the individual coded digital video streams. As used herein, a video stream refers to at least one of a video-only stream, an audio-only stream, or an audiovisual stream.

In some embodiments, the method further comprises receiving selection of one of the individual coded digital video streams; and providing a high-resolution version (e.g., equal to or greater than a first threshold resolution) of the selected coded digital video stream as a separately coded digital video stream.

In some embodiments, the receiving and providing steps are performed by at least one of a video mosaic service server or a user terminal.

In some embodiments, the delivering and providing steps are performed by at least one of a video mosaic service server or a user terminal.

In some embodiments, the individual coded digital video streams are low-resolution digital video streams (e.g., less than a second threshold resolution, wherein the second threshold resolution is less than or equal to the first threshold resolution).

In some embodiments, each individual coded digital video stream is represented by a mosaic component in the video mosaic.

In some embodiments, providing the metadata is associated with Moving Picture Experts Group (MPEG) Dynamic Adaptive Streaming over HyperText Transfer Protocol (DASH) Spatial Relationships Description (SRD).

In some embodiments, a first individual coded digital video stream is not intrinsically related to a second individual coded digital video stream, wherein the first and second individual coded digital video streams are represented by mosaic components comprised in the video mosaic.

In some embodiments, a user terminal that receives the single coded digital video stream comprises at least one of a mobile computing device, a mobile television, a laptop computer, a smart screen, a tablet computer or tablet, a portable desktop computer, a mobile phone, an e-reader, a scanner, a portable media device, a gaming device, a camera or other image-capturing device, headgear, eyewear, a watch, a band, or a wearable device.

In some embodiments, a DASH representation describes the video mosaic.

In some embodiments, a DASH Media Presentation Description (MPD) comprises a Representation associated with the single coded digital video stream.

In some embodiments, the Representation comprises a parameter indicating that a first individual coded digital video stream is not intrinsically linked to a second individual coded digital video stream.

In some embodiments, the Representation comprises a parameter indicating that a first individual coded digital video stream is logically linked to a second individual coded digital video stream.

In some embodiments, the Representation comprises a list of DASH SubRepresentations, each SubRepresentation associated with one of the individual coded digital video streams, each SubRepresentation describing a high-resolution version of one of the individual coded digital video streams.

In some embodiments, each subRepresentation contains a Spatial Relationships Description (SRD) parameter set for one of the individual coded digital video streams, the parameter set including a position in the video mosaic of a mosaic component associated with the individual coded digital video stream, dimensions of the mosaic component, and reference information of a high-resolution version of the individual coded digital video stream.

In some embodiments, the position and the dimensions of the mosaic component are determined by at least one of a video mosaic service server or a user terminal.

In some embodiments, the position and the dimensions of the mosaic component are alterable dynamically in substantially real-time by at least one of the video mosaic service server or the user terminal.

In some embodiments, the position and the dimensions of the mosaic components are configured so that the mosaic components are arranged in a uniform grid.

In some embodiments, the position and the dimensions of the mosaic components are configured so that the mosaic components are of different sizes and are arranged in an arbitrary pattern and whereby some or all of the mosaic components overlap with other mosaic components in the single coded digital video stream.

In some embodiments, an apparatus is configured for providing a mosaic video enabling navigation and selection of components of the mosaic video. The apparatus comprises a memory; a processor; and a module stored in the memory, executable by the processor, and configured for: delivering a single coded digital video stream, the delivered coded digital video stream comprising a video mosaic of individual coded digital video streams that are composited as the single coded digital video stream; and providing metadata for enabling creation of a user interface including the video mosaic, wherein the user interface enables navigation of the video mosaic and selection of the individual coded digital video streams.

In some embodiments, the module is further configured for: receiving selection of one of the individual coded digital video streams; providing a high-resolution version of the selected digital video stream as a separately coded digital video stream; and substantially seamlessly switching from a current digital video stream to the selected coded digital video stream.

In some embodiments, a computer program product is configured for providing a mosaic video enabling navigation and selection of components of the mosaic video, the computer program product comprising a non-transitory computer-readable medium comprising a set of codes for causing a computer to perform: delivering a single coded digital video stream, the delivered coded digital video stream comprising a video mosaic of individual coded digital video streams that are composited as the single coded digital video stream; and providing metadata for enabling creation of a user interface including the video mosaic, wherein the user interface enables navigation of the video mosaic and selection of the individual coded digital video streams.

### BRIEF DESCRIPTION OF THE DRAWINGS

Having thus described embodiments of the invention in general terms, reference will now be made to the accompanying drawings, where:

FIG. 1 is an exemplary screen layout of a 4×4 video mosaic, in accordance with embodiments of the present invention;

FIG. 2 is an exemplary screen layout of a non-uniform video mosaic, in accordance with embodiments of the present invention;

FIG. 3 is an exemplary method for providing a mosaic video service enabling management of user navigation and component selection, in accordance with embodiments of the present invention;

FIG. 4 is an exemplary network environment, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

The following abbreviations are used in this specification:
3GPP 3^{rd} Generation Partnership Project
DASH Dynamic Adaptive Streaming over HTTP
DVB Digital Video Broadcast
HbbTV Hybrid Broadcast Broadband Television
HD High Definition
HTML HyperText Markup Language version 5
HTTP HyperText Transfer Protocol
MPEG Moving Picture Experts Group
SD Standard Definition
SI Service Information
SRD Spatial Relationships Description
MPD Media Presentation Description

It is the purpose of the present invention to describe how video mosaic services can be provided using other delivery systems that do not adopt the MPEG-2 Transport Stream format and DVB signaling specifications, although the present invention may be applied to systems that deliver content within the MPEG-2 Transport Stream format.

For example, such a server-generated video mosaic service can be provided in a delivery network according to the 3GPP set of specifications. In 3GPP audio-visual streamed service delivery is defined in the MBMS set of specifications, i.e. MBMS [2] and 3GP-DASH [3], but there is no method specified to provide a video mosaic service in the same way that is possible in DVB broadcast systems.

The present invention describes a method to provide such a server-generated video mosaic service by adapting a feature contained in the recently published draft of MPEG-DASH Version 2 Amendment 2, namely the SRD—Spatial Relationships Description. Hence the present invention can be used in any content delivery system that uses MPEG DASH to provide the content.

The SRD feature of MPEG-DASH Version 2 Amendment 2 [5] specifies how to signal the relationships between video component streams whereby each component stream constitutes a part of the common full-resolution video stream. Further, two example usages of SRD are described, whereby in each example the component video streams are different versions of the same source video stream.

The present invention adapts the SRD feature to provide the description of a video mosaic service that comprises components that originate from completely different audio-visual services, i.e. they are not related to a common source service nor are they different versions or parts of other component or components. In the present invention, a new type of logical relationship is defined with the SRD usage, namely that the video mosaic component streams are logically related in that they are aggregated in the single composite video mosaic stream provided.

In the present invention, the technical method to include the mosaic service in the user interface at the user terminal is out of scope. Any valid method to provide such an application user interface can include the mosaic service video stream and said component arrangement method within the user application that is created within any kind of applicable application environment. Examples of such application environments are HTML5 and profiles thereof; HbbTV; user interface provision that is integrated into the user terminal DASH client function; or a proprietary application environments or custom created applications for any user terminal device platform that can receive said mosaic service.

### DASH MPD Composition for Mosaic Service

The mosaic service itself is described as a single Representation in the MPD. Each video mosaic component is listed as a sub-Representation comprising the SRD parameters for the component and information about the corresponding full-resolution audio-visual service that is represented in the corresponding video mosaic component.

Each referenced full-resolution video service is listed in the MPD for the mosaic service. For each listed full-resolution service there shall be one SupplementaryProperty element present, with SRD attributes to characterise the corresponding video mosaic component, as defined in the following sub-clause.

This usage of the SubRepresentation, as a virtual video stream that is not actually provided for use on its own by the user terminal, but has been composited into the mosaic video by the mosaic server, might still need some adjustment, e.g. an additional attribute to be signalled in order to differentiate it from the usual usage of Representation and SubRepresentation in MPEG-DASH. One possibility is to define the new DASH MPD role @value of “multiple”, which indicates that the Representation comprises multiple elements that might not have any connection with each other, as is the case with the mosaic service. The meaning of “multiple” may vary according to the type of media content described in the respective MPD Representation, but as described here, for video SubRepresentations it indicates that the Representation comprises of two or more video mosaic components.

### SRD @Value Element Usage for the Video Mosaic Service

The source_id shall preferably be set to some arbitrary value as decided by the service, but it shall be the same value for every video mosaic component listed. Alternatively, source_id might be set to a unique number within the set of sub-Representations comprised in the Representation, if this method has some advantage with the provision of the mosaic service. x shall be the horizontal position of the component video stream expressed as a pixel offset from 0. y shall be the vertical position of the component video stream expressed as a pixel offset from 0. w and h shall be provided to match the actual pixel width and height of the respective mosaic video cell. In this way the user terminal can adapt its user interface navigation mechanism to visualize a pointer or cursor to that portion of the displayed video that is occupied by the respective video mosaic component. As the user navigates around the offered mosaic components using simple cursor motion (for example up, down, left, right, or by swiping on a touch screen), the user terminal can position the cursor to the position to which the user has navigated by knowing the position and size of each component video representation within the single composite video mosaic stream.

By using the actual pixel width and height, the video mosaic service is able to be provided in a flexible manner, leaving the choice of component video stream size to the mosaic service provider. At the same time it is made clear and deterministic to the user terminal how the video mosaic is to be displayed to the user, usually within some application environment.

Preferably the first video mosaic component, i.e., the one positioned top-most and left-most in the video mosaic, shall provide the X and Y parameters, to signal the total width and height of the complete video mosaic video stream. The parameter spatial_set_id is optional according to SRD and it is not needed for the video mosaic service description.

Preferably mosaic components are listed row by row, with the left-most first for each row, and the right-most component last for each row. Thus, the last component listed shall preferably be the bottom-most, right-most component. The precedence for the order of listing of mosaic components is first by horizontal position (x parameter), then vertical position (y parameter), in the case of mosaic components being positioned in a screen area not in a uniform grid of equally sized or equi-distant mosaic components. In this way the arrangement of the mosaic may include component video services

Using the MPD update mechanism documented in MPEG-DASH, a dynamic arrangement of the mosaic service components may be presented, if the mosaic service video component aggregator is capable of such flexible arrangement and encoding of the component video streams into the single composite mosaic service video stream.

Preferably, further components of the video mosaic service are listed in the SRD as EssentialProperty and positioned on the mosaic grid such that no component overlaps with any other component, only when providing a regular grid-format matrix mosaic, and its area does not exceed the bounds of the total area signalled by the X and Y parameters signalled with the first mosaic component.

Mosaic components may be placed adjacent to each other within the screen area covered by the video portion of the mosaic service, or there may be horizontal and/or vertical gaps between successively listed mosaic components. The latter approach allows for example a cursor outline to be placed around the mosaic component by the user terminal application without obscuring the neighbouring mosaic components on the screen.

The mosaic service components may, according to the present invention, be placed at completely arbitrary positions on the chosen display area, and any number of mosaic components may be included, and the components may vary in image size within the mosaic, and they may overlap. In other words, the composition and layout of the component video streams within the mosaic stream is totally at the discretion of the mosaic service provider and capabilities of the mosaic generating equipment.

The parameters bandwidth and StartWithSAP shall be omitted for the SubRepresentations, as these do not represent actual video streams in their mosaic component context.

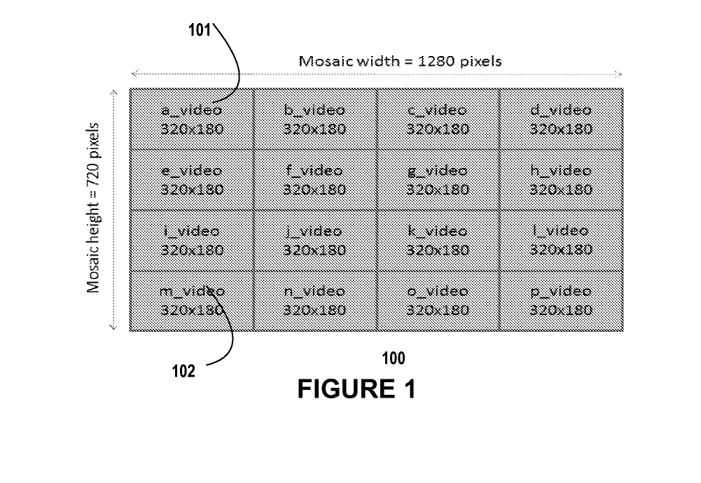

Referring now to FIG. 1, FIG. 1 presents a 4×4 video mosaic 100 of component video services (e.g., 101 and 102), whereby the whole screen or video display window or partial screen area of the user terminal display is occupied by the matrix of video components presented in the mosaic service. The first XML listing presented below is associated with the video mosaic in FIG. 1 and provides an example video mosaic definition. The example applies to the ISO Base media file format On Demand profile as defined in clause 8.3 of [4], but it applies similarly for all other DASH formats and profiles.

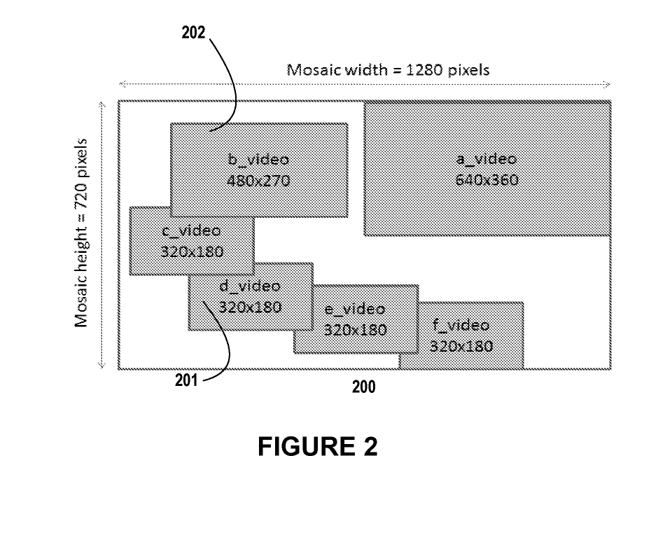

Referring now to FIG. 2, FIG. 2 presents a video mosaic 200 of component video services (e.g., 201 and 202), whereby the components vary in size and are placed in a non-uniform arrangement on the screen area. The second XML listing presented below is associated with the video mosaic in FIG. 2 and provides an example video mosaic definition comprising 4 component video services. The example applies to the ISO Base media file format On Demand profile as defined in clause 8.3 of [4], but it applies similarly for all other DASH formats and profiles.

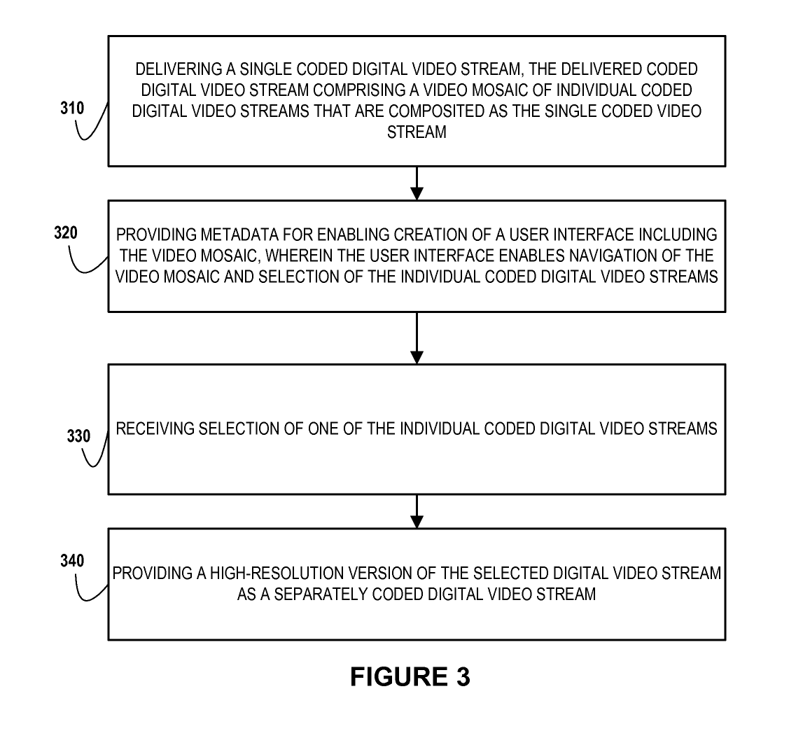

The present invention provides a method, system and computer program product for providing a mosaic video service enabling the management of user navigation and component selection on the user terminal. Referring now to FIG. 3, FIG. 3 presents an exemplary method. A single coded digital video stream is delivered to the user terminal (block 310). The delivered coded digital video stream is a mosaic of several individual coded digital video streams that are composited as a single coded video stream by a video mosaic service server. Metadata is provided to the user terminal to enable the user terminal to create a user interface including the mosaic service, whereby the user is able to navigate the video mosaic and select any of the individual component video services embedded in the single provided composite coded video stream (block 320). When a component is selected (block 330), the user terminal is able to seamlessly switch to the full-resolution (e.g., high-resolution which means equal to or greater than a first threshold resolution) version of the selected service, which is provided in a separate coded video stream (block 340). Provision of the video mosaic metadata is adapted from the feature of MPEG-DASH SRD. The video mosaic service components do not have any direct relationship with each other apart from their aggregation in the video mosaic service that is the subject of the present invention.

A DASH Representation describes the video mosaic service. The DASH MPD role descriptor comprises the new @value “multiple”, or some other mechanism in the DASH MPD to distinguish a Representation that comprises multiple media components that are not intrinsically linked in any way apart from being logically linked in the Representation describing the video mosaic service, in the case of a list of video SubRepresentations. A list of DASH SubRepresentations within said Representation describe the set of full-resolution video components whose reduced-resolution video component is embedded in the composite mosaic video stream. Each sub-Representation comprises the SRD parameter set for a component stream, including the position within the mosaic, and dimensions of the mosaic component, as well as the reference information of the corresponding full-resolution audio-visual service. The reference information comprises a link to the DASH MPD of that service, preferably by usage of the @xlink:href and containing the URI of the MPD of the referenced service. Alternatively, some other method to link to the referenced service, as also may be permitted by the DASH specification, may be appropriate. The positioning and size of the video components may be determined by the mosaic service provider and providing device, to enable versatile and attractive presentation of the mosaic service in the user terminal user interface, and to enable dynamic alterations of the presentation of the mosaic.

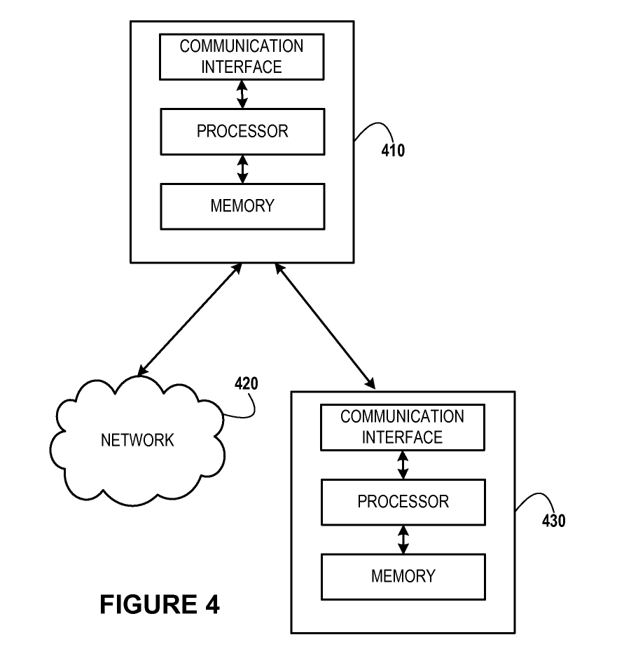

Referring now to FIG. 4, FIG. 4 presents an exemplary block diagram of the network environment, in accordance with embodiments of the present invention. As illustrated, the network environment includes a network 420, a server 430, and a user terminal 410. As shown in FIG. 4, the user terminal 410 and the server 430 are operatively and selectively connected (e.g., via one or more wired or wireless mechanisms) to the network 420, which may include one or more separate networks. The server 430 may be a video mosaic service server.

The user terminal 410 and/or the server 430 in FIG. 4 includes a processor, a memory, and a module stored in the memory, executable by the processor, and configured to perform the various processes described herein, including the capability to communicate with other devices on any network.

Each processor described herein generally includes circuitry for implementing audio, visual, and/or logic functions. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory.

Each memory may include any computer-readable medium. For example, memory may include volatile memory, such as volatile random access memory (RAM) having a cache area for the temporary storage of data. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

The invention is not limited to any particular types of user terminals and/or servers. As used herein, a user terminal and/or server may also be referred to as a device, a system, or apparatus. Examples of user terminals include mobile phones or other mobile computing devices, mobile televisions, laptop computers, smart screens, tablet computers or tablets, portable desktop computers, e-readers, scanners, portable media devices, gaming devices, cameras or other image-capturing devices, headgear, eyewear, watches, bands (e.g., wristbands) or other wearable devices, or other portable computing or non-computing devices. In some embodiments, the user terminal and/or the server may be comprised in the same apparatus.

The various features described with respect to any embodiments described herein are applicable to any of the other embodiments described herein. As used herein, the terms data and information may be used interchangeably. Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. As used herein, “at least one” shall mean “one or more” and these phrases are intended to be interchangeable. Accordingly, the terms “a” and/or “an” shall mean “at least one” or “one or more,” even though the phrase “one or more” or “at least one” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable information processing apparatus in order to produce a particular machine, such that the one or more computer-executable program code portions, which execute via the processor of the computer and/or other programmable information processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable information processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable information processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

The references referred to in the specification are:

```
[1] ETSI EN 300 468: “Digital Video Broadcasting (DVB); Specification for Service
    Information (SI) in DVB systems”
[2] ETSI TS 126.346: Universal Mobile Telecommunications System (UMTS); LTE;
    Multimedia Broadcast/Multicast Service (MBMS); Protocols and codecs (3GPP
    TS 26.346 version 12.3.0 Release 12)
[3] ETSI TS 126.247 : Universal Mobile Telecommunications System (UMTS); LTE;
Transparent end-to-end Packet-switched Streaming Service (PSS); Progressive Download
and Dynamic Adaptive Streaming over HTTP (3GP-DASH) (3GPP TS 26.247 version
12.3.0 Release 12)
[4] ISO/IEC 23009-1 :2014 ed2.0 (2014-05); Information Technology - Dynamic adaptive
    streaming over HTTP (DASH) - Part 1: Media presentation description and
    segment formats
[5] ISO/IEC 23009-1 :201x/FPDAM 2; Information Technology - Dynamic adaptive
    streaming over HTTP (DASH) - Part 1: Media presentation description and
    segment formats / Amd 2
```

The first XML listing presented below is associated with the video mosaic in FIG. 1 and provides an example video mosaic definition (DASH MPD of 4×4 video mosaic).

```
<?xml version=“1.0” encoding=“UTF-8”?>
<MPD
  xmlns=“urn:mpeg:dash:schema:mpd:2011”
  type=“static”
  mediaPresentationDuration=“PT10S”
  minBufferTime=“PT1S”
  profiles=“urn:mpeg:dash:profile:isoff-on-demand:2011”>
  <ProgramInformation>
    <Title>Example of a DASH Media Presentation Description using Spatial Relationships
Description to indicate a video mosaic service</Title>
  </ProgramInformation>
  <Period>
    <AdaptationSet segmentAlignment=“true” subsegmentAlignment=“true”
subsegmentStartsWithSAP=“1”>
      <Role schemeIdUri=“urn:mpeg:dash:role:2011” value=“multiple”/>
      <Representation mimeType=“video/mp4” codecs=“avc1.42c01e” width=“1280”
height=“720” bandwidth=“226597” startWithSAP=“1”>
        <BaseURL> mosaic_video_hd.mp4</BaseURL>
        <SegmentBase indexRangeExact=“true” indexRange=“837-988”/>
<SubRepresentation mimeType=“video/mp4” codecs=“avc1.42c033” width=“320”
height=“180”>
<EssentialProperty schemeIdUri=“urn:mpeg:dash:srd:2014”
value=“0,0,0,320,180,1280,720”/>
<SubRepresentation xlink:href=http://xxx.com/a_service.mpd xlink:actuate=”onRequest”>
        </SubRepresentation>
        <SubRepresentation mimeType=“video/mp4” codecs=“avc1.42c033” width=“320”
height=“180”>
          <EssentialProperty schemeIdUri=“urn:mpeg:dash:srd:2014”
value=“0,320,0,320,180”/>
<SubRepresentation xlink:href=http://xxx.com/b_service.mpd xlink:actuate=”onRequest”>
        </SubRepresentation>
        <SubRepresentation mimeType=“video/mp4” codecs=“avc1.42c033” width=“320”
height=“180”>
          <EssentialProperty schemeIdUri=“urn:mpeg:dash:srd:2014”
value=“0,640,0,320,180”/>
<SubRepresentation xlink:href=http://xxx.com/c_service.mpd xlink:actuate=”onRequest”>
        </SubRepresentation>
        <SubRepresentation mimeType=“video/mp4” codecs=“avc1.42c033” width=“320”
height=“180”>
          <EssentialProperty schemeIdUri=“urn:mpeg:dash:srd:2014”
value=“0,960,0,320,180”/>
<SubRepresentation xlink:href=http://xxx.com/d_service.mpd xlink:actuate=”onRequest”>
        </SubRepresentation>
        <SubRepresentation mimeType=“video/mp4” codecs=“avc1.42c033” width=“320”
height=“180”>
          <EssentialProperty schemeIdUri=“urn:mpeg:dash:srd:2014”
value=“0,0,180,320,180”/>
<SubRepresentation xlink:href=http://xxx.com/e_service.mpd xlink:actuate=”onRequest”>
        </SubRepresentation>
        <SubRepresentation mimeType=“video/mp4” codecs=“avc1.42c033” width=“320”
height=“180”>
          <EssentialProperty schemeIdUri=“urn:mpeg:dash:srd:2014”
value=“0,320,180,320,180”/>
<SubRepresentation xlink:href=http://xxx.com/f_service.mpd xlink:actuate=”onRequest”>
        </SubRepresentation>
        <SubRepresentation mimeType=“video/mp4” codecs=“avc1.42c033” width=“320”
height=“180”>
          <EssentialProperty schemeIdUri=“urn:mpeg:dash:srd:2014”
value=“0,640,180,320,180”/>
<SubRepresentation xlink:href=http://xxx.com/g_service.mpd xlink:actuate=”onRequest”>
        </SubRepresentation>
        <SubRepresentation mimeType=“video/mp4” codecs=“avc1.42c033” width=“320”
height=“180”>
          <EssentialProperty schemeIdUri=“urn:mpeg:dash:srd:2014”
value=“0,960,180,320,180”/>
<SubRepresentation xlink:href=http://xxx.com/h_service.mpd xlink:actuate=”onRequest”>
</SubRepresentation>
        <SubRepresentation mimeType=“video/mp4” codecs=“avc1.42c033” width=“320”
height=“180”>
          <EssentialProperty schemeIdUri=“urn:mpeg:dash:srd:2014”
value=“0,0,360,320,180”/>
<SubRepresentation xlink:href=http://xxx.com/i_service.mpd xlink:actuate=”onRequest”>
        </SubRepresentation>
        <SubRepresentation mimeType=“video/mp4” codecs=“avc1.42c033” width=“320”
height=“180”>
          <EssentialProperty schemeIdUri=“urn:mpeg:dash:srd:2014”
value=“0,320,360,320,180”/>
<SubRepresentation xlink:href=http://xxx.com/j_service.mpd xlink:actuate=”onRequest”>
        </SubRepresentation>
        <SubRepresentation mimeType=“video/mp4” codecs=“avc1.42c033” width=“320”
height=“180”>
          <EssentialProperty schemeIdUri=“urn:mpeg:dash:srd:2014”
value=“0,640,360,320,180”/>
<SubRepresentation xlink:href=http://xxx.com/k_service.mpd xlink:actuate=”onRequest”>
</SubRepresentation>
        <SubRepresentation mimeType=“video/mp4” codecs=“avc1.42c033” width=“320”
height=“180”>
          <EssentialProperty schemeIdUri=“urn:mpeg:dash:srd:2014”
value=“0,960,360,320,180”/>
<SubRepresentation xlink:href=http://xxx.com/l_service.mpd xlink:actuate=”onRequest”>
        </SubRepresentation>
        <SubRepresentation mimeType=“video/mp4” codecs=“avc1.42c033” width=“320”
height=“180”>
          <EssentialProperty schemeIdUri=“urn:mpeg:dash:srd:2014”
value=“0,0,540,320,180”/>
<SubRepresentation xlink:href=http://xxx.com/m_service.mpd xlink:actuate=”onRequest”>
        </SubRepresentation>
        <SubRepresentation mimeType=“video/mp4” codecs=“avc1.42c033” width=“320”
height=“180”>
          <EssentialProperty schemeIdUri=“urn:mpeg:dash:srd:2014”
value=“0,320,540,320,180”/>
<SubRepresentation xlink:href=http://xxx.com/n_service.mpd xlink:actuate=”onRequest”>
        </SubRepresentation>
        <SubRepresentation mimeType=“video/mp4” codecs=“avc1.42c033” width=“320”
height=“180”>
          <EssentialProperty schemeIdUri=“urn:mpeg:dash:srd:2014”
value=“0,640,540,320,180”/>
<SubRepresentation xlink:href=http://xxx.com/o_service.mpd xlink:actuate=”onRequest”>
        </SubRepresentation>
        <SubRepresentation mimeType=“video/mp4” codecs=“avc1.42c033” width=“320”
height=“180”>
          <EssentialProperty schemeIdUri=“urn:mpeg:dash:srd:2014”
value=“0,960,540,320,180”/>
            <SubRepresentation xlink:href=http://xxx.com/p_service.mpd
xlink:actuate=”onRequest”>
        </SubRepresentation>
      </Representation>
    </AdaptationSet>
  </Period>
</MPD>
```

The second XML listing presented below is associated with the video mosaic in FIG. 2 and provides an example video mosaic definition.

```
<?xml version=“1.0” encoding=“UTF-8”?>
<MPD
  xmlns=“urn:mpeg:dash:schema:mpd:2011”
  type=“static”
  mediaPresentationDuration=“PT10S”
  minBufferTime=“PT1S”
  profiles=“urn:mpeg:dash:profile:isoff-on-demand:2011”>
  <ProgramInformation>
    <Title>Example of a DASH Media Presentation Description using Spatial Relationships
Description to indicate a video mosaic service</Title>
  </ProgramInformation>
  <Period>
    <AdaptationSet segmentAlignment=“true” subsegmentAlignment=“true”
subsegmentStartsWithSAP=“1”>
      <Role schemeIdUri=“urn:mpeg:dash:role:2011” value=“multiple”/>
      <Representation mimeType=“video/mp4” codecs=“avc1.42c01e” width=“1280”
height=“720” bandwidth=“226597” startWithSAP=“1”>
        <BaseURL> mosaic_video_hd.mp4</BaseURL>
        <SegmentBase indexRangeExact=“true” indexRange=“837-988”/>
        <SubRepresentation mimeType=“video/mp4” codecs=“avc1.42c033” width=“640”
height=“360”>
          <EssentialProperty schemeIdUri=“urn:mpeg:dash:srd:2014”
value=“0,640,0,640,360,1280,720”/>
<SubRepresentation xlink:href=http://xxx.com/a_service.mpd xlink:actuate=”onRequest”>
        </SubRepresentation>
        <SubRepresentation mimeType=“video/mp4” codecs=“avc1.42c033” width=“480”
height=“270”>
          <EssentialProperty schemeIdUri=“urn:mpeg:dash:srd:2014”
value=“0,100,20,480,270”/>
<SubRepresentation xlink:href=http://xxx.com/b_service.mpd xlink:actuate=”onRequest”>
        </SubRepresentation>
        <SubRepresentation mimeType=“video/mp4” codecs=“avc1.42c033” width=“320”
height=“180”>
          <EssentialProperty schemeIdUri=“urn:mpeg:dash:srd:2014”
value=“0,20,280,320,180”/>
<SubRepresentation xlink:href=http://xxx.com/c_service.mpd xlink:actuate=”onRequest”>
        </SubRepresentation>
        <SubRepresentation mimeType=“video/mp4” codecs=“avc1.42c033” width=“320”
height=“180”>
          <EssentialProperty schemeIdUri=“urn:mpeg:dash:srd:2014”
value=“0,120,440,320,180”/>
<SubRepresentation xlink:href=http://xxx.com/d_service.mpd xlink:actuate=”onRequest”>
        </SubRepresentation>
        <SubRepresentation mimeType=“video/mp4” codecs=“avc1.42c033” width=“320”
height=“180”>
          <EssentialProperty schemeIdUri=“urn:mpeg:dash:srd:2014” value=“0,380,480,320,
180”/>
<SubRepresentation xlink:href=http://xxx.com/e_service.mpd xlink:actuate=”onRequest”>
        </SubRepresentation>
        <SubRepresentation mimeType=“video/mp4” codecs=“avc1.42c033” width=“320”
height=“180”>
          <EssentialProperty schemeIdUri=“urn:mpeg:dash:srd:2014”
value=“0,680,400,320,180”/>
            <SubRepresentation xlink:href=http://xxx.com/f_service.mpd
xlink:actuate=”onRequest”>
        </SubRepresentation>
      </Representation>
    </AdaptationSet>
  </Period>
</MPD>
```

What is claimed is:

1. A method for providing a mosaic video enabling navigation and selection of components of the mosaic video, the method comprising:
delivering a single coded digital video stream, the delivered coded digital video stream comprising a video mosaic of individual coded digital video streams that are composited as the single coded digital video stream;
providing metadata for enabling creation of a user interface including the video mosaic, wherein the user interface enables navigation of the video mosaic and selection of the individual coded digital video streams.

2. The method of claim 1, further comprising:
receiving selection of one of the individual coded digital video streams; and
providing a high-resolution version of the selected coded digital video stream as a separately coded digital video stream.

3. The method of claim 2, wherein the receiving and providing steps are performed by at least one of a video mosaic service server or a user terminal.

4. The method of claim 1, wherein the delivering and providing steps are performed by at least one of a video mosaic service server or a user terminal.

5. The method of claim 1, wherein the individual coded digital video streams are low-resolution digital video streams.

6. The method of claim 1, wherein each individual coded digital video stream is represented by a mosaic component in the video mosaic.

7. The method of claim 1, wherein providing the metadata is associated with Moving Picture Experts Group (MPEG) Dynamic Adaptive Streaming over HyperText Transfer Protocol (DASH) Spatial Relationships Description (SRD).

8. The method of claim 1, wherein a first individual coded digital video stream is not intrinsically related to a second individual coded digital video stream, wherein the first and second individual coded digital video streams are represented by mosaic components comprised in the video mosaic.

9. The method of claim 1, wherein a user terminal that receives the single coded digital video stream comprises at least one of a mobile computing device, a mobile television, a laptop computer, a smart screen, a tablet computer or tablet, a portable desktop computer, a mobile phone, an e-reader, a scanner, a portable media device, a gaming device, a camera or other image-capturing device, headgear, eyewear, a watch, a band, or a wearable device.

10. The method of claim 1, wherein a DASH representation describes the video mosaic.

11. The method of claim 10, wherein a DASH Media Presentation Description (MPD) comprises a Representation associated with the single coded digital video stream.

12. The method of claim 11, wherein the Representation comprises a parameter indicating that a first individual coded digital video stream is not intrinsically linked to a second individual coded digital video stream.

13. The method of claim 11, wherein the Representation comprises a parameter indicating that a first individual coded digital video stream is logically linked to a second individual coded digital video stream.

14. The method of claim 11, wherein the Representation comprises a list of DASH SubRepresentations, each SubRepresentation associated with one of the individual coded digital video streams, each SubRepresentation describing a high-resolution version of one of the individual coded digital video streams.

15. The method of claim 14, wherein each subRepresentation contains a Spatial Relationships Description (SRD) parameter set for one of the individual coded digital video streams, the parameter set including a position in the video mosaic of a mosaic component associated with the individual coded digital video stream, dimensions of the mosaic component, and reference information of a high-resolution version of the individual coded digital video stream.

16. The method of claim 15, wherein the position and the dimensions of the mosaic component are determined by at least one of a video mosaic service server or a user terminal.

17. The method of claim 16, wherein the position and the dimensions of the mosaic component are alterable dynamically in substantially real-time by at least one of the video mosaic service server or the user terminal.

18. The method of claim 16, wherein the position and the dimensions of the mosaic components are configured so that the mosaic components are arranged in a uniform grid.

19. The method of claim 16, wherein the position and the dimensions of the mosaic components are configured so that the mosaic components are of different sizes and are arranged in an arbitrary pattern and whereby some or all of the mosaic components overlap with other mosaic components in the single coded digital video stream.

20. An apparatus configured for providing a mosaic video enabling navigation and selection of components of the mosaic video, the apparatus comprising:
a memory;
a processor; and
a module stored in the memory, executable by the processor, and configured for:
delivering a single coded digital video stream, the delivered coded digital video stream comprising a video mosaic of individual coded digital video streams that are composited as the single coded digital video stream;
providing metadata for enabling creation of a user interface including the video mosaic, wherein the user interface enables navigation of the video mosaic and selection of the individual coded digital video streams.

21. The apparatus of claim 20, wherein the module is further configured for:
receiving selection of one of the individual coded digital video streams;
providing a high-resolution version of the selected coded digital video stream as a separately coded digital video stream; and
substantially seamlessly switching from a current digital video stream to the selected coded digital video stream.

22. A computer program product configured for providing a mosaic video enabling navigation and selection of components of the mosaic video, the computer program product comprising:
a non-transitory computer-readable medium comprising a set of codes for causing a computer to perform:
delivering a single coded digital video stream, the delivered coded digital video stream comprising a video mosaic of individual coded digital video streams that are composited as the single coded digital video stream;
providing metadata for enabling creation of a user interface including the video mosaic, wherein the user interface enables navigation of the video mosaic and selection of the individual coded digital video streams.
